(19) United States
(12) Patent Application Publication
(10) Pub. No.: US 2019/0314656 A1
(43) Pub. Date: Oct. 17, 2019

(54) ENERGY ABSORBER

(71) Applicant: Pure Safety Group, Inc., Pasadena, TX (US)

(72) Inventors: William Leo FARRELL, Kent, WA (US); Jason Mathew MOORE, Graham, WA (US)

(73) Assignee: Pure Safety Group, Inc., Pasadena, TX (US)

(21) Appl. No.: 16/278,240

(22) Filed: Feb. 18, 2019

Related U.S. Application Data
(60) Provisional application No. 62/656,783, filed on Apr. 12, 2018.

(51) Int. Cl. A62B 35/04; F16F 7/00; F16F 7/12; A62B 35/00

(52) U.S. Cl. CPC A62B 35/04; F16F 7/003; F16F 7/128; F16F 2236/06; F16F 2224/0208; F16F 2224/0233; F16F 2234/06; A62B 35/0056

(57) ABSTRACT

An energy absorber comprises a base having a weakened portion, a mounting aperture, and a connecting aperture. An energy absorber assembly includes the energy absorber, an anchor member extending through the connecting aperture, a mounting bracket including an aperture, and a fastener extending through the aperture of the mounting bracket and the mounting aperture of the energy absorber.

This application claims the benefit of U.S. Provisional Patent Application 62/656,783, filed Apr. 12, 2018.

### BACKGROUND

Fall protection equipment is commonly used to reduce a likelihood of a fall and/or injuries associated with a fall, particularly by users who perform tasks at heights or are at risk of falling. Generally, lifelines and/or lanyards typically interconnect anchorage structures and safety harnesses donned by users. The lifelines and/or lanyards allow the users to move and perform tasks while being connected to the anchorage structures. Should a user fall, the lifeline and/or lanyard limits the distance the user falls.

An example of one type of fall protection equipment is a horizontal lifeline assembly including at least two anchorage structures (e.g., stanchions) between which a lifeline extends. The user may connect to the lifeline, for example with a lanyard, and move along the length of the lifeline. The horizontal lifeline assembly may include an energy absorber to absorb energy should a fall occur.

### SUMMARY

Examples of the disclosure provide an energy absorber. In one aspect, an energy absorber comprises a base having a weakened portion, a mounting aperture, and a connecting aperture.

In another aspect, the base is a disk member.

In another aspect, the disk member is round.

In another aspect, the weakened portion includes a plurality of alternating connected portions and cuts extending through the base.

In another aspect, the cuts are elongated.

In another aspect, the weakened portion is arranged in a spiral configuration.

In another aspect, the weakened portion forms an elongating portion having an intermediate portion interconnecting a distal end and a proximal end, the distal end being positioned proximate a center of the spiral configuration and the proximal end being positioned proximate an outer portion of the spiral configuration, the distal end and the intermediate portion being configured to separation from the base and deform to absorb energy.

In another aspect, the connecting aperture is proximate a center of the spiral configuration and the mounting aperture is proximate an outer portion of the spiral configuration.

In another aspect, an anchor member extends through the connecting aperture and a mounting bracket is operatively connected to the base for use as an energy absorber assembly, wherein a fastener extends through an aperture in the mounting bracket and the mounting aperture in the base to interconnect the mounting bracket and the base.

In another aspect, a horizontal lifeline assembly includes an energy absorber.

In another aspect, an energy absorber assembly comprises an energy absorber, an anchor member, and a mounting bracket. The energy absorber includes a base having a weakened portion, a mounting aperture, and a connecting aperture. The anchor member extends through the connecting aperture. The mounting bracket includes an aperture, and a fastener extends through the aperture of the mounting bracket and the mounting aperture of the energy absorber.

### BRIEF DESCRIPTION OF THE DRAWINGS

The accompanying drawings are included to provide a further understanding of examples and are incorporated in and constitute a part of this specification. The drawings illustrate examples and together with the description serve to explain principles of examples. Other examples and many of the intended advantages of examples will be readily appreciated as they become better understood by reference to the following detailed description. The elements of the drawings are not necessarily to scale relative to each other. Like reference numerals designate corresponding similar parts.

FIG. 1 is a perspective view of an example energy absorber;

FIG. 2 is a front view of another example energy absorber;

FIG. 3 is a side view of the energy absorber shown in FIG. 1;

FIG. 4 is a side view of an example horizontal lifeline assembly including an example energy absorber such as the energy absorber shown in FIG. 1;

FIG. 5 is a side view of the horizontal lifeline assembly shown in FIG. 4 that has been subjected to a force and the energy absorber has been deployed;

FIG. 6 is a perspective view of the energy absorber shown in FIG. 5;

FIG. 7 is an exploded perspective view of an energy absorber assembly including the energy absorber shown in FIG. 1; and

FIG. 8 is a portion of an example horizontal lifeline assembly including the energy absorber assembly shown in FIG. 7.

### DETAILED DESCRIPTION

In the following Detailed Description, reference is made to the accompanying drawings, which form a part hereof, and in which is shown by way of illustration specific examples in which the invention may be practiced. In this regard, directional terminology, such as “top,” “bottom,” “front,” “back,” “leading,” “trailing,” etc., is used with reference to the orientation of the Figure(s) being described. Because components of examples can be positioned in a number of different orientations, the directional terminology is used for purposes of illustration and is in no way limiting. It is to be understood that other examples may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary examples described herein may be combined with each other, unless specifically noted otherwise.

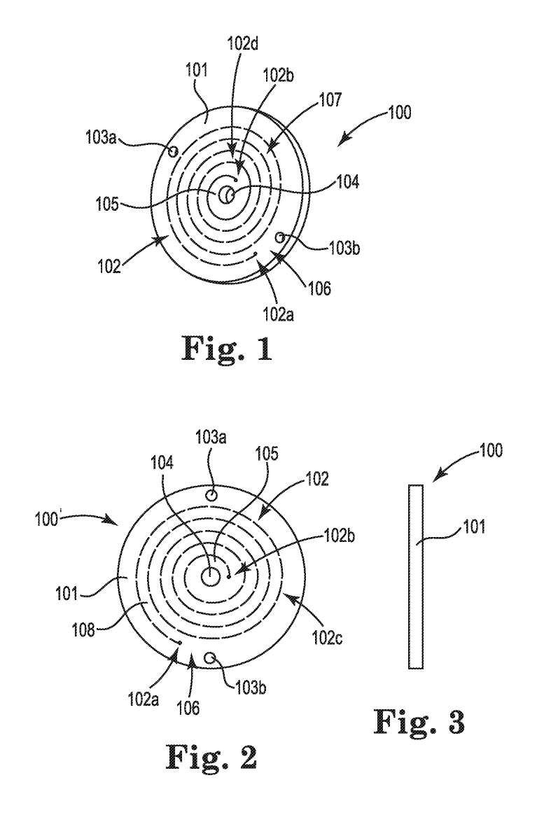

Example energy absorbers 100 and 100′ are illustrated in FIGS. 1-3. The energy absorbers each include a base 101, which in these examples is generally a round disk member, but it is recognized that other suitable shapes could be used. The disk member may be made of stainless steel and may have a thickness of approximately 0.25 to 0.50 inch. Other suitable materials and thicknesses could be used.

A weakened portion is arranged on the base 101. In some examples, the weakened portion 102 includes a plurality of alternating connected portions and cuts or voids extending through the base 101 that provide guidance for a separation pattern in the base 101. In some examples, the cuts or voids are elongated. It is recognized that score lines, perforations, or other suitable weakened portions could be used in lieu of alternating connected portions and cuts or voids to form the weakened portion.

The weakened portion 102 includes a first end 102a and a second end 102b interconnected by an intermediate portion 102c. As shown in FIGS. 1 and 2, the separation pattern is generally a spiral configuration, but other suitable separation patterns could be used. The weakened portion 102 could include a generally consistent pattern or configuration and/or an inconsistent or varied pattern or configuration. For example, in energy absorber 100 shown in FIG. 1, the weakened portion 102 includes a cut portion proximate the second end 102b approximately one revolution of the spiral configuration until a first interruption 102d (e.g., connected portion). In another example, in energy absorber 100′ shown in FIG. 2, the plurality of alternating connected portions and cuts or voids extends from the first end 102a to the second end 102b. It is recognized that other suitable patterns or configurations could be used.

The weakened portion 102 forms an elongating portion 108 extending between the first end 102a and the second end 102b. The elongating portion 108 includes a distal end 105 proximate the second end 102b, a proximal end 106 proximate the first end 102a, and an intermediate portion 107 extending between the distal end 105 and the proximal end 106. In a spiral configuration, the distal end 105 is preferably positioned proximate a center of the spiral configuration and the proximal end 106 is preferably positioned proximate an outer portion of the spiral configuration. The distal end 105 and the intermediate portion 107 are configured and arranged to separate and/or deform from the remainder of the base 101 along the weakened portion 102 from proximate the distal end 105 up to proximate the proximal end 106 to absorb energy when subjected to a force exceeding a predetermined threshold.

The weakened portion 102 and/or the elongating portion 108 may separate and/or deform when subjected to a predetermined threshold that is either relatively consistent or varied from proximate the distal end 105 to proximate the proximal end 106. In some examples, the weakened portion 102 and/or the elongating portion 108 separates and/or deforms when subjected to a first predetermined threshold proximate the distal end 105 and at least one predetermined threshold between the first predetermined threshold and the proximal end 106 that is different than the first predetermined threshold. For example, the ease at which the weakened portion 102 and/or the elongating portion 108 separates and/or deforms could vary between the distal end 105 and the proximal end 106.

For example, as shown in FIG. 1, energy absorber 100 includes the cut portion from proximate the second end 102b to the first interruption 102d and, therefore, a portion of the base 101 proximate the distal end 105 separates and/or deforms from the remaining portion of the base 101 at a lower predetermined threshold than the remaining portion of the base 101 between the first interruption 102d and the first end 102a. In another example, as shown in FIG. 2, energy absorber 100′ includes a relatively consistent weakened portion 102 from proximate the distal end 105 to proximate the proximal end 106.

The base 101 also includes at least one mounting aperture and a connecting aperture. In some examples, a first mounting aperture 103a and a second mounting aperture 103b are positioned on opposing sides of the base 101. Preferably, at least one of the mounting apertures 103a and 103b is positioned proximate the proximal end 106 and the outer portion of the spiral configuration and the connecting aperture 104 is positioned proximate the distal end 105 and the center of the spiral configuration.

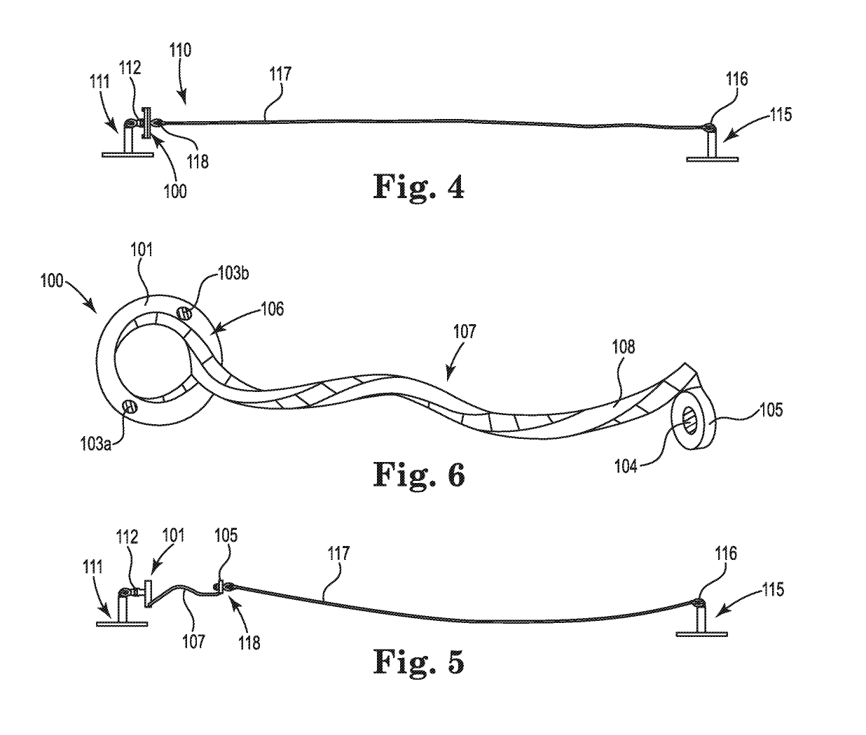

An example use of the energy absorber is with a horizontal lifeline assembly, and an example horizontal lifeline assembly 110 is illustrated in FIGS. 4 and 5. The horizontal lifeline assembly 110 includes at least two anchorage structures, for example a first stanchion 111 and a second stanchion 115, with a lifeline 117 extending therebetween.

The energy absorber 100 is connected to the first stanchion 111 with a first connecting member 112 and fasteners (not shown). The first connecting member 112 could be a plate or bracket member. The fasteners extend through the mounting apertures 103a and 103b and into the first connecting member 112.

One end of the lifeline 117 is connected to the distal end 105 with a fastener 118. The fastener 118 could be an eyebolt and a nut or a swivel eye secured to the distal end 105 by a bolt and a nut. The other end of the lifeline 117 is connected to the second stanchion 115 with a second connecting member 116. The second connecting member 116 could be a tensioner, such as a turnbuckle or other tensioning member.

In operation, a user connects to the lifeline 117, for example with a lanyard connected to the user's safety harness, and the user may move along the length of the lifeline 117. Should the user fall, force is exerted upon the lifeline 117, which transfers to the energy absorber 100. As force exceeding a predetermined threshold is exerted upon the energy absorber 100, the elongating portion 108 begins to deploy. The distal end 105 is pulled in a direction away from the remaining portion of the base 101 and the weakened portion 102 begins to separate thereby separating the distal end 105 from the remaining portion of the base 101. The weakened portion 102 continues to separate from the remaining portion of the base 101 along the intermediate portion 107 toward the proximal end 106. As the elongating portion 108 deploys, it deforms from a generally spiral configuration to a generally outwardly extended, linear configuration, as shown in FIG. 6. The separation from the base 101 and the deformation assist in absorbing energy. In addition, the energy absorber could provide indication that force has been exerted on the horizontal lifeline assembly and it could require repair.

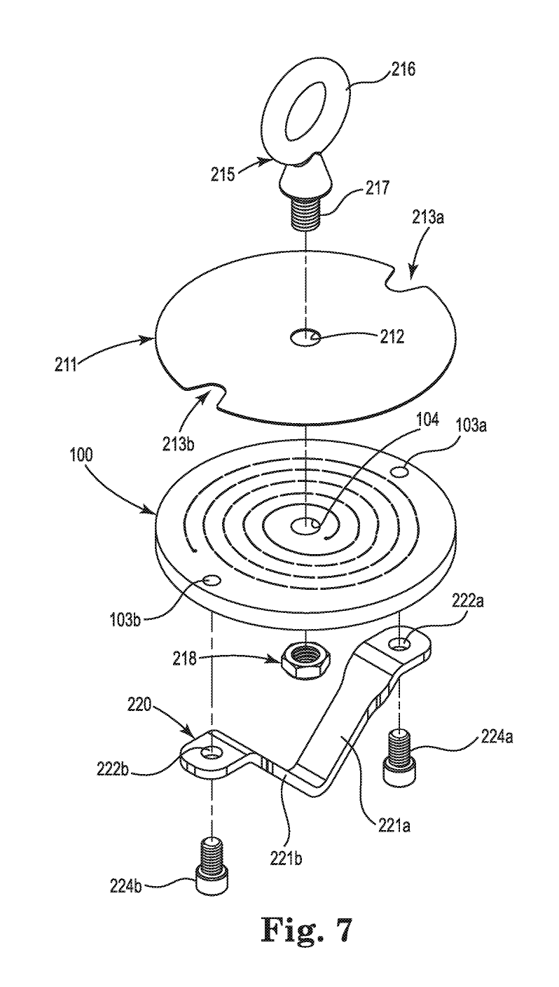

The energy absorber could be a component of an energy absorber assembly configured and arranged to connect to an anchorage structure (e.g., a stanchion). An example energy absorber assembly includes an energy absorber, for example the energy absorber 100, and connecting components. This is shown in FIG. 7. An optional label 211 could be positioned on one side of the energy absorber 100, and the label 211 could include an aperture 212 and notches 213a and 213b or apertures corresponding with the connecting aperture 104 and mounting apertures 103a and 103b of the energy absorber base 101. An eyebolt 215 could be used as an anchor member on the energy absorber 100. The eyebolt 215 includes a connecting portion 216 and a threaded shaft 217. The threaded shaft 217 is configured and arranged to extend through the connecting aperture 104, and a nut 218 is threaded onto the shaft 217 to secure the eyebolt 215 to the base 101. Fasteners 224a and 224b extend through apertures 222a and 222b in legs 221a and 221b of a mounting bracket 220 and through apertures 103a and 103b in the base 101 to connect the mounting bracket 220 to the base 101. The mounting bracket could be any suitable configuration, and one example configuration is generally a V-shape formed by legs 221a and 221b.

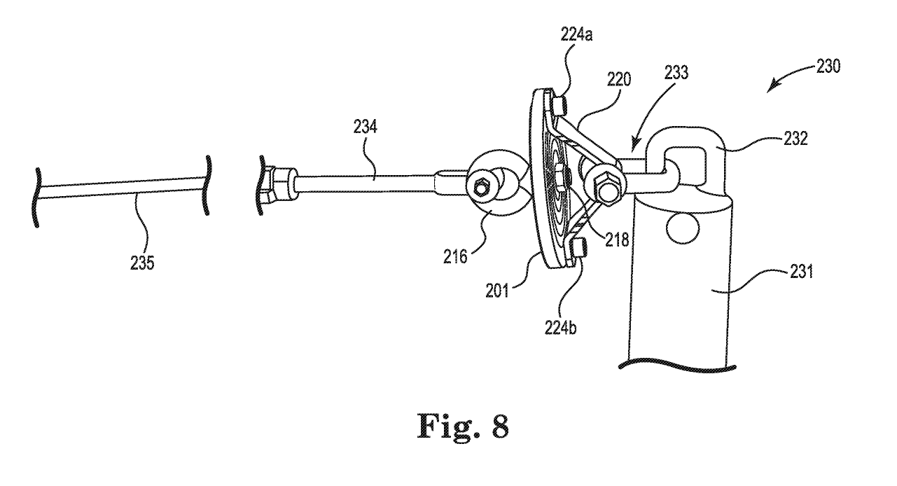

The energy absorber assembly could be connected to a horizontal lifeline system 230 such as that shown in FIG. 8. A stanchion 231 including a connecting portion 232 could be connected to the mounting bracket 220 with a connector 233 such as a shackle or other suitable connector. An end of a cable 235 may be directly or indirectly connected to the connecting portion 216 of the eyebolt 215 by connecting means well known in the art. For example, as shown in FIG. 8, a turnbuckle 234 or any other suitable connector could be used.

In operation, should a user fall, force is exerted upon the lifeline 235, which transfers to the energy absorber 100. As force exceeding a predetermined threshold is exerted upon the energy absorber 100, the elongating portion 108 begins to deploy as previously described.

Although specific examples have been illustrated and described herein, it will be appreciated by those of ordinary skill in the art that a variety of alternate and/or equivalent implementations may be substituted for the specific examples shown and described without departing from the scope of the present invention. This application is intended to cover any adaptations or variations of the specific examples discussed herein. Therefore, it is intended that this invention be limited only by the claims and the equivalents thereof.

What is claimed is:

1. An energy absorber, comprising:
a base;
a weakened portion in the base, the weakened portion being arranged in a spiral configuration;
a mounting aperture in the base proximate an outer portion of the spiral configuration; and
a connecting aperture in the base proximate a center of the spiral configuration.

2. The energy absorber of claim 1, wherein the base is a disk member.

3. The energy absorber of claim 2, wherein the disk member is round.

4. The energy absorber of claim 1, wherein the weakened portion includes a plurality of alternating connected portions and cuts extending through the base.

5. The energy absorber of claim 4, wherein the cuts are elongated.

6. The energy absorber of claim 1, wherein the weakened portion forms an elongating portion having an intermediate portion interconnecting a distal end and a proximal end, the distal end being positioned proximate the center of the spiral configuration and the proximal end being positioned proximate the outer portion of the spiral configuration, the distal end and the intermediate portion being configured to separation from the base and deform to absorb energy.

7. The energy absorber of claim 1, further comprising:
an anchor member extending through the connecting aperture;
a lifeline operatively connected to the anchor member;
an anchorage structure; and
a mounting bracket interconnecting the base and the anchorage structure.

8. The energy absorber of claim 7, wherein the anchorage structure is a stanchion.

9. The energy absorber of claim 1, further comprising:
an anchor member extending through the connecting aperture; and
a mounting bracket operatively connected to the base, wherein a fastener extends through an aperture in the mounting bracket and the mounting aperture in the base to interconnect the mounting bracket and the base.

10. The energy absorber of claim 9, further comprising:
a lifeline operatively connected to the anchor member; and
an anchorage structure operatively connected to the mounting bracket.

11. The energy absorber of claim 10, wherein the anchorage structure is a stanchion.

12. An energy absorber, comprising:
a base having a weakened portion, a mounting aperture, and a connecting aperture;
an anchor member extending through the connecting aperture;
a mounting bracket including an aperture; and
a fastener extending through the aperture of the mounting bracket and the mounting aperture of the energy absorber.

13. The energy absorber of claim 12, wherein the weakened portion is arranged in a spiral configuration.

14. The energy absorber of claim 13, wherein the weakened portion forms an elongating portion having an intermediate portion interconnecting a distal end and a proximal end, the distal end being positioned proximate a center of the spiral configuration and the proximal end being positioned proximate an outer portion of the spiral configuration, the distal end and the intermediate portion being configured to separation from the base and deform to absorb energy.

15. The energy absorber of claim 12, wherein the connecting aperture is proximate a center of the spiral configuration and the mounting aperture is proximate an outer portion of the spiral configuration.

16. The energy absorber of claim 12, further comprising:
a lifeline operatively connected to the anchor member; and
an anchorage structure operatively connected to the mounting bracket.

17. The energy absorber of claim 16, wherein the anchorage structure is a stanchion.
